(19) United States
(12) Patent Application Publication
(10) Pub. No.: US 2005/0250358 A1
(43) Pub. Date: Nov. 10, 2005

(54) Arrangement with a tubular housing for an energy transmission device

(75) Inventors: Andreas Ebner, Nurnberg (DE); Hermann Koch, Gerhardshofen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/120,196

(22) Filed: May 3, 2005

(30) Foreign Application Priority Data
May 4, 2004 (DE) 10 2004 023139.7

(51) Int. Cl. H01R 4/66

(52) U.S. Cl. 439/95

(57) ABSTRACT

An energy transmission device has a tubular housing. Arranged inside the tubular housing is an electrical conductor. The electrical conductor is mounted on the tubular housing by mounts. To prevent the electrical conductor from vibrating, a supporting element is additionally arranged between the tubular housing and the electrical conductor. The supporting element has a variable extent and may be configured for example in the form of a cushion.

### CLAIM FOR PRIORITY

This application claims priority to German Application No. 10 2004 023 139.7, filed May 4, 2004, which is incorporated herein, in its entirety, by reference.

### TECHNICAL FIELD OF THE INVENTION

The invention relates to an arrangement with a tubular housing for an energy transmission device, with an electrical conductor and with a supporting element for supporting the electrical conductor on the tubular housing.

### BACKGROUND OF THE INVENTION

An example of a tubular housing for an energy transmission device can be seen, as an example, in U.S. Pat. No. 5,565,652. In the case of the energy transmission device disclosed therein, an electrical conductor is arranged inside a tubular housing. The electrical conductor is supported on the housing by means of supporting elements. The electrical energy transmission device is made up of individual segments. The individual segments have different lengths. When laying the known energy transmission device, the individual segments are preassembled, the preassembled segments are transported to the construction site and are put together there. The transportation makes the tubular housing, the supporting elements and the electrical conductor undergo vibration. These vibrations may cause damage to the prefabricated segments. To avoid damage, cautious transportation and cautious assembly on the construction site are necessary. This requires an increased amount of time to be expended for the transportation, storage and assembly of the known segments of an energy transmission device.

### SUMMARY OF THE INVENTION

The invention is directed to designing an arrangement with a tubular housing for an energy transmission device in such a way that quick and careful transportation and quick assembly of the segments of the energy transmission device are made possible.

The object is achieved in the case of an arrangement of the type mentioned at the beginning by the extent of the supporting element in the supporting direction being variable.

According to an aspect of the invention, adjustability of the extent of the supporting element in the supporting direction makes it possible to produce additional bracing between the electrical conductor and the housing. Vibrating of the conductor is suppressed as a result. The extent can be changed for example by scissor- or pantograph-like or telescopic elements.

Advantageously, it may further be provided that the changing of the extent of the supporting element can be brought about by a variably fillable expansion chamber.

The expansion chamber changes its volume during filling, for example, with a fluid such as a gas or liquid. This may take place, for example, by the expansion chamber being formed by an elastic membrane which expands under increased pressure. Furthermore, the expansion chamber may also be realized by rigid bodies which are movable in relation to one another, such as, for example, piston-cylinder arrangements. Expansion chambers of this type have the advantage that they have a comparatively small volume in the non-expanded state. On account of the small spatial extent, very compact supporting elements can be formed, easily able to be brought to their place of use through narrow constrictions. Only when they are in their place of use does filling of the expansion chamber take place, and consequently changing of the extent of the supporting element in the supporting direction. Further suitable constructions for changing the extent of the supporting element in the supporting direction may be formed, for example, by supporting elements which can be made to extend in a scissors-like or pantograph-like manner.

According to a further aspect of the invention, the supporting element may be reversibly deformable.

For certain applications it is advantageous if the supporting element only supports the electrical conductor for a time. This may be envisaged, for example, during assembly. After reversal of the deformation, the supporting element can easily be removed from the tubular housing. The reversible deformation may, in this case, be brought about, for example, by emptying a previously filled expansion chamber. Furthermore, reversible deformation of the supporting elements may also be realized by hinge-like constructions or telescopic constructions on the supporting element.

According to a further aspect of the invention, the supporting element may be arranged on the electrical conductor alongside a fixed mount of the electrical conductor.

By arranging the supporting element alongside a fixed mount, for example, an insulating support or disk insulator, it is possible to rely on the mechanical properties of the fixed mount. In this way it is possible, for example, to design the supporting element in a rather filigree form and to use the supporting element only in an assisting way to support the electrical conductor, while a large part of the conductor is supported by the fixed mount. A lightweight construction of the supporting element allows simplified handling and a reduction in the external dimensions of the supporting element. As a result, the supporting element is flexibly movable, even through narrow constrictions. At the same time, the handling of a lightweight supporting element is possible in a simple way.

According to yet another aspect of the invention, the expansion chamber may be arranged in a cushion-like manner between the electrical conductor and an inner wall of the tubular housing.

A cushion-like expansion chamber can be inserted relatively easily into different surface formations, depending on the degree to which it is filled. For instance, in a particularly lightweight variant of a supporting element, it is formed by a cushion-shaped expansion chamber being inserted directly between the inner wall of the tubular housing and the electrical conductor. The flexibly deformable surface of the cushion-shaped expansion chamber comes to bear snugly against the inner wall of the tubular housing and against the more highly curved jacket of the electrical conductor. The soft structure of the filled expansion chamber means that there is no fear of damaging the surface of the inner wall or the surface of the electrical conductor.

According to a further aspect of the invention, the supporting element may substantially comprise a fillable flexible cushion.

A supporting element which substantially comprises a fillable flexible cushion can be produced extremely inexpensively. A supporting element of this type may, for example, also be intended for single use and be sent for disposal once it has been used.

Furthermore, it may advantageously be provided that the supporting element is a vibration-damping transport securing element.

Transportation of preassembled tubular housings with built-in electrical conductors is accompanied by vibrations. To prevent the electrical conductor vibrating inside the tubular housing, the supporting element according to the invention can be used as a transport securing device. Transport securing devices of this type must be able to be introduced into the tubular housing as simply as possible and also easily removed from it. Moreover, transport securing devices must be as inexpensive as possible. A supporting element which is variable in its extent meets such requirements. In particular, a supporting element formed as a flexibly fillable cushion which, when filled, unfolds and presses itself between the electrical conductor and the inner wall of the tubular housing is suitable as a transport securing device.

### BRIEF DESCRIPTION OF THE DRAWINGS

The invention is schematically shown in the drawings and explained in more detail below on the basis of an exemplary embodiment.

FIG. 1 shows a section through a tubular housing with an electrical conductor and a supporting element,

FIG. 2 shows a section through the arrangement represented in FIG. 1, and

FIG. 3 shows a further section through an arrangement with a tubular housing and an electrical conductor.

### DETAILED DESCRIPTION OF THE INVENTION

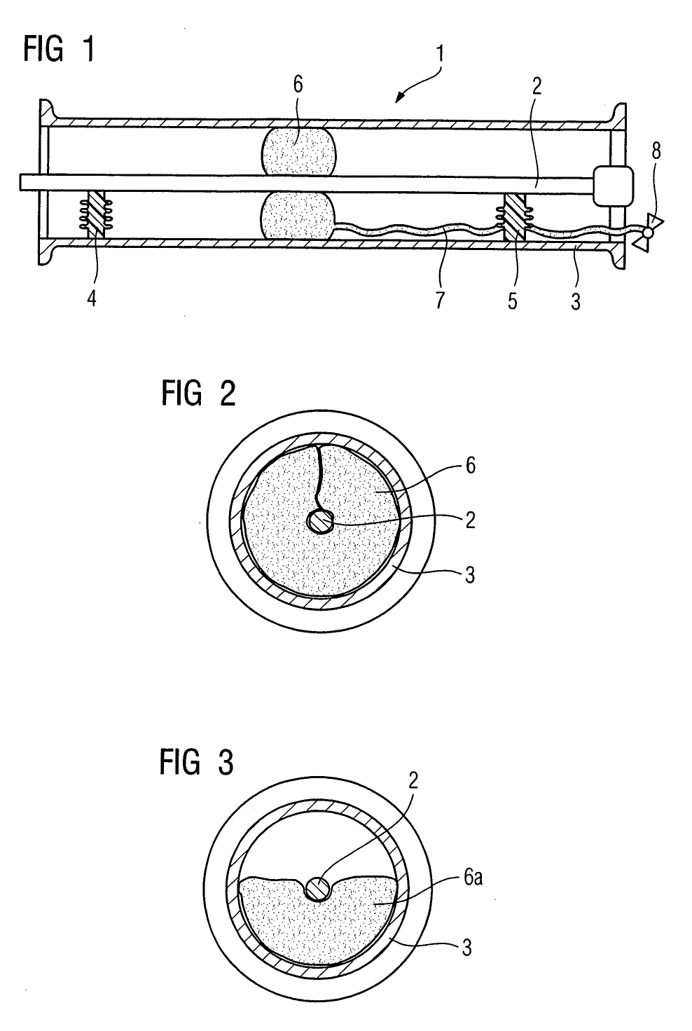

FIG. 1 shows a section through an energy transmission device 1, which has an electrical conductor 2, which is arranged inside a tubular housing 3. The electrical conductor 2 is supported on the tubular housing 3 by a first mount 4 and a second mount 5. The first and second mounts 4, 5 are configured in the present case as supporting insulators. The tubular housing 3 is formed from an electrically conducting material. Alternatively, it may also be envisaged to produce the tubular housing from an insulating material and the mounts from an electrically conducting material. A multiplicity of tubular housings 3 along with electrical conductors 2 are flanged-mounted end to end, so that an elongated energy transmission device is obtained. This makes it possible to transmit electrical energy, for example, from a power generating plant into an urban conurbation.

The first mount 4 and the second mount 5 are arranged spaced apart from each other along the tube axis of the tubular housing 3. This spacing is chosen such that, with the smallest possible number of mounts, the conductor 2 does not sag at all. In the stationary case, i.e. in the mounted state of the energy transmission device 1, the overall system is no longer moved, i.e. no vibrations are externally imposed on the housing 3 or the electrical conductor 2. During transportation of preassembled housings 3, the spacing between the first mount 4 and the second mount 5 is too great, however, to keep the electrical conductor 2 free from vibrations. For example, when a housing 3 and a built-in electrical conductor 2 are loaded and transported, the electrical conductor 2 undergoes vibration. As a result, the mechanical connection between the electrical conductor 2 and the first and second mounts 4, 5 is subjected to loading. By introducing an easy-to-handle and inexpensive transport securing device, such vibration is restricted. The transport securing device is formed as a supporting element 6 which is variable in its extent in the supporting direction. The supporting element 6 is configured as an inflatable cushion which unfolds in the intermediate space between the tubular housing 3 and the electrical conductor 2 and presses itself into the electrical conductor 2. The supporting element 6 is pushed in the non-unfolded state into the tube to the location of the intended support. In this state, the supporting element 6 can be handled like a mat and can be easily displaced and deformed. The supporting element 6 can be filled, for example with compressed air, via a tube 7 connected to the supporting element 6. With the filling of the expansion chamber of the supporting element 6, the expansion chamber unfolds and comes to bear snugly against the inner wall of the housing 3 and against the outer jacket surface of the electrical conductor 2. When the desired filling is achieved, the tube 7 can be closed by a valve 8. The electrical conductor 2 is then secured against vibrations.

In FIG. 2, a side view of the expanded supporting element 6 is represented. The form of the supporting element 6 is chosen in this case such that the electrical conductor 2 is surrounded in an annular manner once expansion has taken place.

FIG. 3 shows an alternative configuration of a supporting element 6a. The supporting element 6a is designed in such a way that only certain portions of the electrical conductor are supported. Complete support of the electrical conductor 2 in all radial directions can take place, for example, by using a number of supporting elements 6a which are arranged offset in relation to one another.

Once the supporting element 6 is no longer required, the expansion chamber can be emptied via the tube 7 and the valve 8. As a result, the supporting element 6 resumes a relaxed form and can be flexibly removed from the tubular housing 3, even through small openings.

Apart from use of a supporting element according to the invention as a transport securing device, it may also be envisaged for supporting elements of this type to be used for permanently remaining in an energy transmission device.

1. An arrangement with a tubular housing for an energy transmission device, comprising:
an electrical conductor;
a supporting element for supporting the electrical conductor on the tubular housing, wherein the extent of the supporting element in a supporting direction is variable.

2. The arrangement as claimed in claim 1, wherein a change of the extent of the supporting element can be effected by a variably fillable expansion chamber.

3. The arrangement as claimed in claim 1, wherein the supporting element is reversibly deformable.

4. The arrangement as claimed in claim 1, wherein the supporting element is arranged on the electrical conductor alongside a fixed mount of the electrical conductor.

5. The arrangement as claimed in claim 2, wherein the expansion chamber is arranged in a cushion-like manner between the electrical conductor and an inner wall of the tubular housing.

6. The arrangement as claimed in claim 1, wherein the supporting element substantially comprises a fillable flexible cushion.

7. The arrangement as claimed in claim 1, wherein the supporting element is a vibration-damping transport securing device.
